(19) United States
(12) Patent Application Publication
(10) Pub. No.: US 2009/0037279 A1
(43) Pub. Date: Feb. 5, 2009

(54) Dynamic Creation of Personalized Presentations For Network Communication Systems

(75) Inventors: Ganapathy Chockalingam, La Jolla, CA (US); Sujit Dey, La Jolla, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ortiva Wireless, Inc., La Jolla, CA (US)

(21) Appl. No.: 12/180,445

(22) Filed: Jul. 25, 2008

Related U.S. Application Data
(60) Provisional application No. 60/952,513, filed on Jul. 27, 2007.

(51) Int. Cl. G06Q 30/00; H04N 7/025; G06F 17/00; G06F 15/16; G06F 7/10; G06F 17/30

(52) U.S. Cl. 705/14; 725/34; 715/234; 709/204; 709/206; 707/5; 707/E17.014

(57) ABSTRACT

A personalized presentation is provided to an intended recipient through a network communication system by selecting personalization content for an associated presentation template in accordance with contemporaneous information relating to an intended recipient and generating an assembled presentation comprising the selected personalization content and the associated presentation template such that the assembled presentation can be sent to the intended recipient.

### BACKGROUND

Modern network communication systems permit communications to a large number of users. Such message systems can include voice and mobile Web communications over cellular telephone networks, Internet communications to computers over wired and wireless connections, and email message networks. These systems can support large-scale simultaneous communications of one-to-many, sometimes referred to as broadcast messages. Large-scale messaging is useful in efficiently distributing advertisements and other marketing efforts.

Unsolicited broadcast messages and similar communications are often considered by recipients as an intrusion, because they were not requested by the recipient. Such unsolicited communications are typically referred to as “spam” in a derogatory categorization. Another reason that advertising communications or ads (in the discussion herein, “advertisement” and “ad” will be used interchangeably) are often ignored is that they are typically impersonal and therefore contain content with little or no relevance to the recipient. Conventional ad personalization is typically “personalized” on a superficial level, based on group demographics or special interest groups and the like, or is directed to particular Web sites (e.g., through the use of Internet cookies). Again, the content often has little relevance (or interest) to the recipient. User acceptance and positive response to ads sent over network communications would be increased if the ads provided a presentation that was personalized in a way that is more relevant to the recipient and if they were sent with prior approval.

It should be apparent that network communications such as ads with an improved personalized presentation for recipients are needed. The present invention satisfies this need.

### SUMMARY

In accordance with embodiments described herein, personalized presentations are dynamically created and provided through a network communication system by selecting personalization content for an associated presentation template in accordance with contemporaneous information relating to an intended recipient and generating an assembled presentation comprising the selected personalization content and the associated presentation template such that the assembled presentation can be sent to the intended recipient. The personalized presentation can comprise, for example, advertising content (also referred to as “creative”) and the network communication system can comprise a mobile Web system or other network-based communications. Thus, a variety of content can be personalized, including ad coupons, banner ads, Web pages, email messages, and the like. The personalized presentation can be sent to intended recipients. The personalized presentation can be sent independently of other content, as a solitary communication, or the personalized presentation can be sent before or after accompanying content or in conjunction with other content. The contemporaneous information is obtained substantially at the time the assembled presentation is generated. The contemporaneous information is collected with the acquiescence of the intended recipient. In this way, the personalized presentation is more likely to be relevant to the intended recipient and is more likely to be accepted by the intended recipient.

If desired, the contemporaneous information relating to the intended recipient can include user preferences of the intended recipient, device resources information, and user location. The user location can comprise currently available physical location, which can comprise static location information or dynamic location information. The assembled presentation can comprise a coupon for redemption, such that the coupon can be printed out and redeemed at the convenience of the recipient. Alternatively, the coupon can comprise a received message or a display that is stored on the recipient device, which may comprise a device such as a Web-enabled telephone or PDA or the like, so that the coupon is redeemed by presentation of the recipient device at a redemption location. In this way, the content can comprise an assembled presentation based on the selected presentation template in accordance with the selected personalization content and the physical location to provide a personalized presentation that is more likely to be accepted, viewed, and utilized in the desired fashion.

The content can be selected from an ingest module that maintains presentation template information and personalization content. The assembled presentation can be generated by a template engine that generates the assembled presentation for an intended recipient in accordance with personalization content and presentation template information selected from the ingest module in accordance with contemporaneous information relating to the intended recipient. The template engine can be operated by a service provider or by a sponsor. The presentation template can be selected in accordance with a theme or campaign goal desired by a sponsor, such as a particular advertiser. The personalization content for the assembled presentation can be based on user preference data, for example using data such as provided by a user who is registered with an advertiser or sponsor, or otherwise indicates approval to receive ads. The user preferences may relate to self-reported user interests, user demographics, account information, browsing and call experience, redemption history, and the like. The user physical location can be determined from user location data of the intended recipient at the time of generating the assembled message, such as current geographic location or a location otherwise associated with the intended recipient. Device resources can include display capabilities such as resolution and screen size, processing power such as device CPU, and the like.

Other features and advantages of the present invention should be apparent from the following description of exemplary embodiments, which illustrate, by way of example, aspects of the invention.

### BRIEF DESCRIPTION OF THE DRAWINGS

FIG. 1 is a block diagram of a system constructed in accordance with the invention for dynamically generating personalized presentations.

FIG. 2 is a flowchart of content generation operations performed by the FIG. 1 system.

FIG. 3 is a display of a user device illustrating the personalized presentation produced by the system of FIG. 1.

FIG. 4 is a block diagram of the FIG. 1 system.

### DETAILED DESCRIPTION

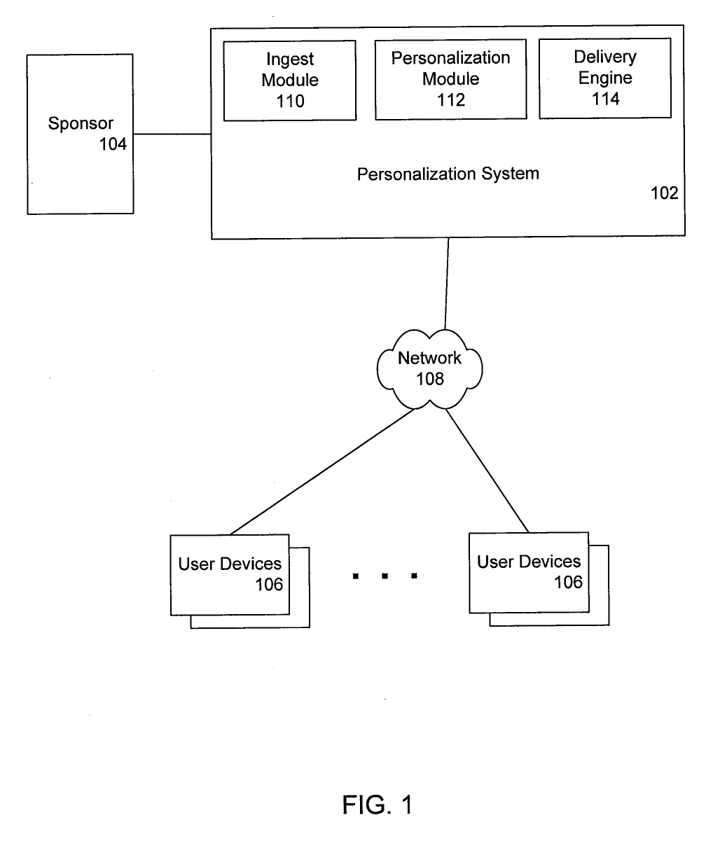

FIG. 1 shows a system 100 constructed in accordance with the description herein. The system 100 includes a personalization system 102 that generates assembled content based on user information and content source information obtained from a sponsor 104. The content assembled for presentation is personalized for particular users (intended recipients) based on contemporaneous user information and content information, and the assembled content is delivered to the intended recipients at their corresponding user devices 106 over a communication network 108. The communication network 108 can comprise, for example, a cellular telephone network, the Internet, or other communications networks. In the discussion that follows, “users” and “user devices” and “intended recipients” will be used interchangeably for each other, unless the context requires otherwise. The communications between the sponsor 104 and personalization system 102 can also take place over such networks 108. The sponsor 104 can, if desired, perform the operations of the system 102. In that situation, the sponsor and personalization system could be co-located and would comprise an integrated ad server.

The personalization system 102 can include components comprising an ingest module 110 that maintains user information and content information, a personalization module 112 that assembles the content from a combination of static and dynamic information described further below, and a delivery engine 114 that is responsible for sending the assembled content to the intended recipients. If desired, the ingest module, personalization module, and delivery engine can be independently located and operated, within the functions described herein. Alternatively, they can be integrated in any combination or subcombination.

The user devices 106 can each comprise a mobile handheld computing device such as a Web-enabled cellular telephone or Blackberry®/Treo® device or Web-enabled PDA devices. The user devices 106 can also comprise laptop or desktop computers, or other devices capable of network communications with the personalization system 102. The user devices will include central processor units (CPUs) for controlling device operations, network communications interfaces, input mechanisms such as keyboards, and output mechanisms such as visual displays. Such details are conventional and will be understood by those skilled in the art without further description.

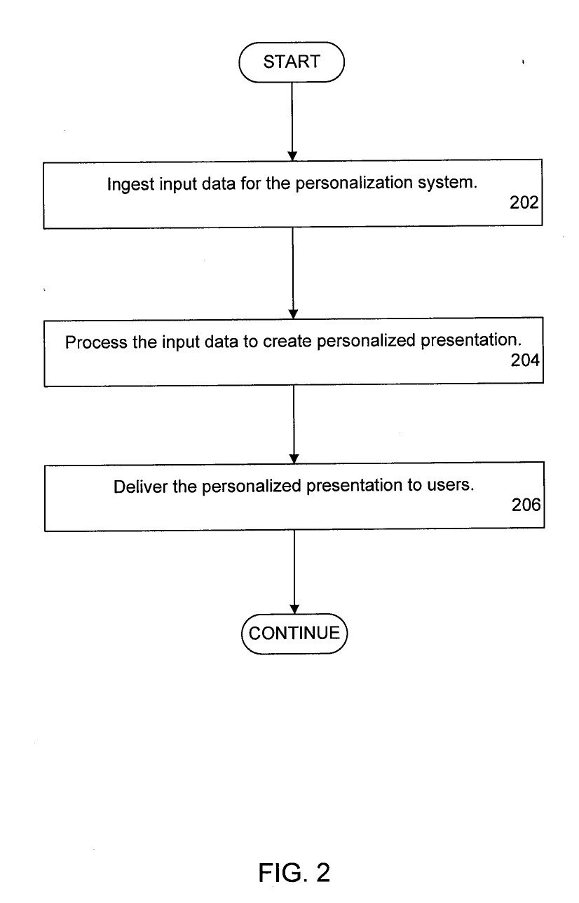

FIG. 2 is a flowchart of the operations performed by the FIG. 1 system. In the first operation, indicated by the flow diagram box numbered 202, input data for the personalization system 102 of FIG. 1 is selected, or ingested. The input data may be selected from a variety of sources, typically including data from sponsors of the personalized presentation being generated, such as advertising clients. The input data generally includes promotional information, such as advertising content, and user profile data, such as user preferences and characteristics. After the input data is obtained, the next operation (at box 202) is to process the input data to dynamically generate assembled content that is personalized for an intended recipient (i.e., a user) in accordance with contemporaneous user information. The assembled content typically comprises a personalized ad. At box 206, the assembled content comprising a personalized presentation is delivered to the intended recipient at a corresponding user device, such as at a handheld computing device or the like.

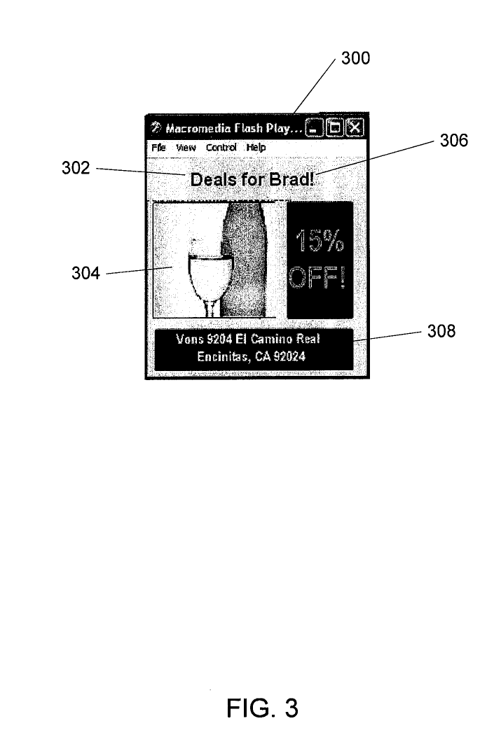

FIG. 3 shows a display 300 of a user device 106 (FIG. 1) and illustrates personalized presentation produced by the system 100 of FIG. 1. The personalized presentation as illustrated in FIG. 3 comprises an ad message that was generated at the personalization system 102, which is maintained by a personalization service provider or by a sponsor. The ad message was delivered to the user device over the network 108. The ad message was generated in accordance with contemporaneous user information at the time the content was assembled and delivered. The personalized ads are generated by the system 102 on behalf of client sponsors, such as retail establishments or producers of goods and services that are the subject of the personalized ads, or the ads can be generated by the sponsors themselves, or other intermediaries.

The personalized ad can provide a coupon that can be redeemed at a retail location or redemption location. For example, the display of FIG. 3 might include a network link to Web content from which a coupon can be printed out, or may provide a Web page address at which a coupon can be downloaded at a later time, or the display may permit the user recipient to download or store the ad message so that the receiving device itself could be presented at a retail location or redemption center to obtain the benefit advertised in the ad message. Upon presentation of the receiving device, the ad message can be retrieved for display to appropriate persons (and redemption) or its receipt at the user device can be confirmed by suitable data reading devices. Other mechanisms for confirming receipt of the personalized ad message for purposes of redeeming or utilizing the advertised benefit will occur to those skilled in the art in view of the description herein. Alternatively, the personalized presentation such as the ad message may comprise banner ads, Web pages, email messages, and the like and can be sent independently of other content, as a solitary communication, or the personalized presentation can be sent before or after accompanying content or in conjunction with other content. For example, the personalized presentation can comprise content that is sent before or after a sponsored multimedia clip or other general content, or the personalized presentation can be sent as a personalized banner ad that accompanies other content.

The personalized presentation shown on the display 300 in FIG. 3 is dynamically assembled from static content and dynamic content. An example of the static content shown on the display 300 is data that does not change with different personalized ads, such as the caption “Deals for” 302 of the FIG. 3 caption. An example of the dynamic content is the advertising message 304, which in the illustration comprises a graphic (image) that depicts bottled wine available at a discount. The personalized presentation comprising an advertising message is contemporaneously assembled for the intended recipient, who is identified by personal content 306 of the message as “Brad”. The personal content completes the caption of the ad message, which in its entirety reads “Deals for Brad! ”. The personal content changes with the intended recipient, and therefore is a type of dynamic content. For example, for a sponsor comprising a general store or grocery store, the message or graphic 304 might be for medicines or recreational equipment rather than bottled wine. Additional dynamic content can include location-based content 308, which in FIG. 3 identifies the location of a particular retail outlet at which the advertising message can be redeemed or utilized. The identified location of the personalized ad will typically be selected in accordance with the location of the intended recipient at the time the personalized ad is generated. The sponsor, and the message 304 itself, could also be selected on the basis of the identified location.

The ad message of the display 300 is generated by the personalization system 102 from a combination of template data and dynamic data. The dynamic data is obtained from databases and system components from which the dynamic content described above can be generated. For example, the network location and contact addresses for intended recipients will typically be obtained from user databases available from the sponsors. The template data is obtained from template information that is generated in accordance with the preferences of the sponsors on whose behalf the personalized presentation is being generated.

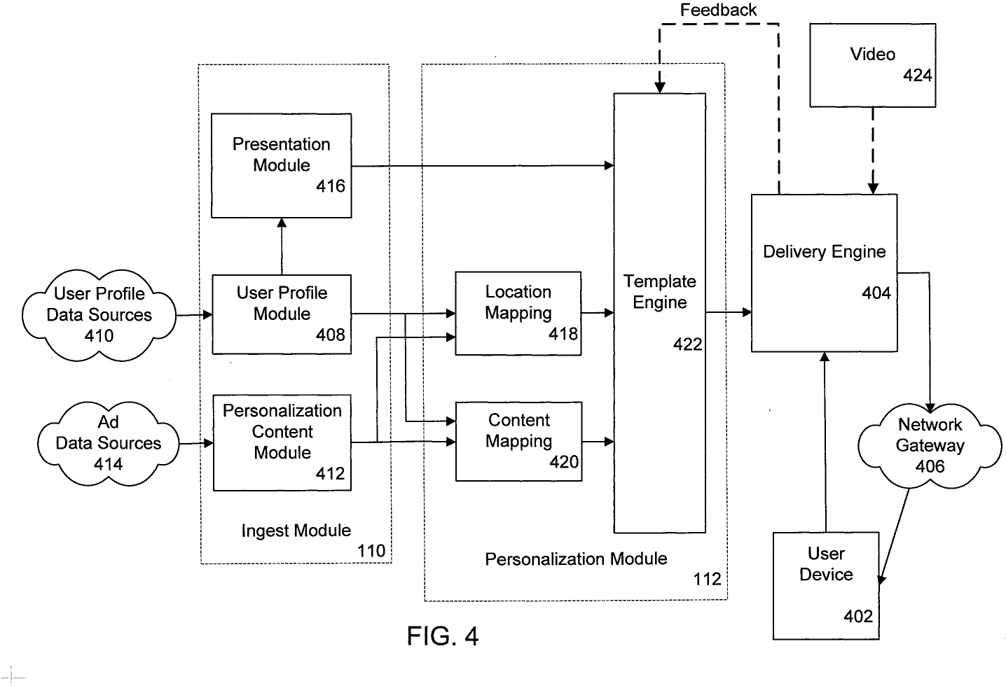

FIG. 4 is a block diagram of the FIG. 1 system and illustrates the information flow in the system operations. A user device 402 participates in a communication session with a delivery engine 404 over a communications network, such as via a network gateway 406. The user device receives a personalized presentation from the delivery engine 404, which can be part of the personalization system or can be a server external to the delivery engine that is responsible for network transport of the personalized presentation. In this discussion, the user device 402 will be used interchangeably with “user” and “recipient” as context requires to refer to the receipt and/or viewing of the personalized presentation. As part of the initial ingest operation for generating the personalized presentation, a user profile module 408 obtains user profile information from user profile data sources 410. Typically, the user profile data will be selected from the sponsors of the personalized presentation and may be obtained in the form of XML data or the like, for integration with presentation templates.

A personalization content module 412 selects content, such as the advertising message content illustrated above in conjunction with discussion of FIG. 3. The personalization content is obtained from content data sources 414. Typically, the content will be obtained from the sponsors and may be received in the form of XML data or the like, for integration with presentation templates. For example, sponsors may maintain databases of user profile data and advertising content, to which the personalization system is granted access.

As noted above, assembled presentations are generated with a combination of information that includes presentation template data. For example, a presentation template module 416 can select an ad template in accordance with a theme or campaign goal desired by a sponsor, such as a sponsor's advertising campaign. The presentation templates can be obtained from a database maintained by the sponsor (not illustrated in FIG. 4) or by the personalization system itself, or by a combination of the two. The presentation templates comprise a collection of templates in various formats suited for different device platforms and messaging protocols, such as SMS, MMS, Flash Lite®, and the like. The templates are typically maintained in data storage of the presentation template module 416, but may be stored in external data locations accessible by the module. The user profile module 408, personalization content module 412, and presentation template module 416 comprise the ingest module 110 illustrated in FIG. 1 (indicated by dashed lines in FIG. 4).

The presentation templates from which the template module 416 selects are generally developed in consideration of devices to be supported and message protocols to be utilized, and also can be developed to serve the purposes of ad message campaigns of sponsors. For example, ad campaigns might be directed to sales and promotion, or new user acquisition, or new product announcements, and brand enhancement. Other uses will occur to those skilled in the art. In the illustrated system of FIG. 1, the templates include placeholders for static content and dynamic content, into which promotional content and location specific content will be inserted. See, for example, the exemplary display of FIG. 3.

The template engine 422 can generate personalized presentations and can also select content appropriate for the current network communication session based on feedback from the delivery engine 404 in accordance with recipient factors such as network bandwidth for the current session, device type resources, and user geographic location. The personalized presentation may be provided for insertion into a video stream received from a video provider 424. For example, a video clip or movie might be streamed to a user 402 and, during the communication session for the video streaming, a personalized presentation comprising an ad may be scheduled for viewing. If the communication session bandwidth changes from the time the live clip is started to the time within the clip that the personalized presentation is scheduled, then the changed bandwidth may become known to the template engine 422 via the feedback provided by the delivery engine 404. The optional nature of the feedback from the delivery engine 404 to the template engine 422 is indicated by the dashed line in FIG. 4. Thus, the template engine 422 can be informed of changes in the communication session with the user 402 via the optional feedback from the delivery engine 422. As described above, other features of the recipient user 402 may become known to the template engine 422 through the user profile data sources 410.

In this way, the delivery engine 404 can be used to inject personalized advertisements into a video stream from a source 424. Thus, changes during the communication session between the delivery engine 404 and the user device 402 will drive the creation and insertion of a personalized presentation (e.g., an appropriate ad) in the video stream 424. For example, if templates or content of different resolutions or bitrates are available to the template engine 422, then the template or content that is appropriate to current network communication session conditions will be selected by the template engine at the time the personalized presentation is assembled and dynamically created for delivery to the user. Thus, the quality of the personalized presentation can be adjusted for the network conditions at the time of the delivery, and can be adjusted for each user device 402 that is to receive a personalized presentation. The current network communication session conditions may be known by a variety of techniques that will be known to those skilled in the art. For example, techniques may be employed that are described in “V-SHAPER: An Efficient Method of Serving Video Streams Customized for Diverse Wireless Communication Conditions”, by C. Taylor and S. Dey, in IEEE Communications Society, Proceedings of Globecomm 2004 (Nov. 29-Dec. 3, 2004) at 4066-4070.

For the dynamic creation of personalized presentations during a video stream, the delivery engine 404 receives as inputs a personalized presentation from the template engine 422 and a video source stream 424. The delivery engine inserts the personalized presentation at the desired time slot of the video stream. For example, the personalized presentation may comprise an advertising clip that is to be run at 2:30 (2 minutes 30 seconds) into a video stream. The delivery engine 404 receives the video content 424 and at the appointed time inserts the personalized presentation. The personalized presentation may comprise any content that is personalized as described herein, such as multimedia content with features tailored to an intended recipient.

The video portion preceding the insertion time slot, and the personalized presentation, may be received at the delivery engine 404 at a time that is minimally sufficient to process the material (i.e., video frames) before delivery to the recipient 402. More precisely, because the personalized presentation is dynamically created according to the network conditions, it is advantageous if the dynamic creation of the personalized presentation occurs as close in time as possible to the actual network transport to the user 402, so that the personalized presentation is created in accordance with current network conditions and user characteristics such as user location. This maximizes the increased granularity of personalization that can be provided by the system 100. The amount of time necessary to perform such personalization with computer processor assistance can be in near real-time (i.e., fractions of a second). The personalized presentation itself may be inserted at any point in the video stream, at the beginning, the end, or at an intermediate location of the video stream. Thus, the output of the template engine 422 is a video that contains personalized advertisement content.

The template engine 422 could also create a personalized presentation that is based on the feedback from the delivery engine in accordance with factors such as the current communication network transport conditions. The quality of the selected presentation will depend on the feedback parameters for optimized and efficient delivery. As in the case of the personalized presentation, the delivery engine can insert the selected presentation at the desired time slot. For example, the template engine may select a template family (e.g., particular subject matter or creative) at the beginning of a communication session. The template family may comprise multiple versions (such as resolutions) of otherwise identical content. The template engine then selects the proper template version at the time of dynamically creating the personalized presentation in accordance with the then-current communication conditions. The personalization templates can be stored in accordance with an XML schema that includes the placeholders for content to be provided at the time of content assembly. For example, a suitable XML schema for use in the system of FIG. 1 to store user information is provided below in Table 1:

TABLE 1

<user>
<name>
<first>Adam</first>
<last>Jones</last>
</name>
<age>36</age>
<zip>92121</zip>
<device>
<make>Motorola</make>
<model>i58</model>
</device>
<preferences>
<category>alcohol</category>
<category>pet care</category>
</preferences>
</user>

In Table 1, the user preferences are arranged into categories that comprise predetermined product lines, in the case of this user, comprising “alcohol” and “pet care”. Those skilled in the art will appreciate that other categories can be selected, in accordance with the purposes for which the content is to be personalized and pursuant to the interests of the sponsors or others on whose behalf the personalized presentation is being generated. The XML schema for representation is especially suited to dynamic generation of the personalized presentations described herein, as parameter values can be used to dynamically generate content.

A suitable XML schema for use in the system of FIG. 1 to store ad (promotional) content information is provided below in Table 2:

TABLE 2

<adcampaign type=‘promotion’>
<corporation>Acme Supermarket</corporation>
<outlets>
<address>
<street>123 Main St</street>
<city>Any City</city>
<state>CA</state>
<zip>92230</zip>
</address>
<address>
<street>343 Willow St</street>
<city>Next City</city>
<state>CA</state>
<zip>92130</zip>
</address>
</outlets>
<promotions>
<product>
<name>Coppolo Rosa</name>
<category>alcohol</category>
<image>rossa.jpg</image>
<discount type=“percent”
expires=“7/23/07”>15</discount>
</product>
<product>
<name>cola drink 24pk</name>
<category>soft drink</category>
<image>cola.jpg</image>
<discount type=“cash”
expires=“7/23/07”>2.00</discount>
</product>
</promotions>
</adcampaign>

In Table 2, the information includes specification of the ad campaign type and addresses (locations) of retail outlets or redemption locations for the personalized presentation ad message. The products and/or services that are part of the ad message campaign are specified, in this example comprising a wine in the product category “alcohol” and a beverage in the “soft drink” category. In each case, a product image is provided for display at the user device of the intended recipient, along with a discount or promotion feature, in these exemplary cases, a price discount promotion. Other potentially useful discounts and features provided by the ad message will occur to those skilled in the art. Each presentation format that is supported (such as SMS messaging, MMS, mobile Web pages, and the like) will be provided with a corresponding presentation template to ensure that personalized presentation of proper format will be generated for the intended recipient.

Thus, as part of the ingest operations, input data for the user profile module 408 and personalization content module 412 is collected and maintained in data storage associated with the respective modules. The collected data may include information such as promotional content, location data for redemption centers and retail outlets, pricing information, user information regarding user product preferences and interests, user device type information, and user location. The user location may comprise currently available physical location, and may comprise static location information, such as a home address or mailing address or fixed network IP address, or may comprise dynamic location information, such as current geographic location of the user device obtained from handset information (e.g. cell tower) or dynamic network location such as obtained from GPS locating data. The input data may be received in the form of XML data, or other similar formats that will occur to those skilled in the art. The databases associated with the modules 408, 412, 416 illustrated in FIG. 4 are maintained as relational databases for efficient operation. The promotional content may be received directly from ad sources such as creative agencies and advertising providers with whom the sponsors and ad server work. Similarly, the user profile information may come directly from sponsoring entities that have information relating to the intended recipients, or from retail establishments that maintain such data. Other and additional message formats and data structures may be used, in accordance with system design preferences.

The personalization operations performed by the FIG. 1 system include processing the input data comprising data from databases accessed by the user profile module 408 and the presentation content module 412. The promotional content can be based on contemporaneous user preference data such as provided by a user who is registered with an advertiser or sponsor, or otherwise indicates approval to receive the personalized presentation. The user preferences may relate to self-reported user interests, user demographics, account information, browsing and call experience, redemption history, and the like. For example, the system may process a data base that identifies intended recipients and may select personalized presentation for a template associated with each intended recipient in accordance with contemporaneous information related to each intended recipient. The system can generate an assembled presentation with the selected personalized presentation so that the assembled presentation can be provided to the intended recipient. The assembled presentation can be provided by transport over a communication network.

As noted above, the user location can be determined from currently available user physical location data of the intended recipient at the time of generating the assembled personalized presentation, such as current geographic location or a location otherwise associated with the intended recipient. For example, many cellular telephones, smart phones, and similar devices report their location based on GPS-receiver sets with which they are equipped, and report back to their telecommunications carrier, through which the personalization engine can receive such data. Alternatively, users may register their “home” geographic location to received relevant content for that locale. The system is configured to retrieve and determine such user location information at the time of assembling personalized presentation, so that updates to databases concerning such location data will be propagated to the personalization system and incorporated in the personalized presentation. Thus, the user location is contemporaneously determined when the personalized presentation is generated. Device resources that will be known to the personalization engine can include display capabilities such as resolution and screen size, processing power such as device CPU, and the like.

The presentation template module 416 receives user profile data from the user profile module 408 and selects the appropriate presentation template in accordance with the data. For example, the content format (such as SMS, MMS, Flash Lite®, html, and the like) will be selected based on the capabilities of the device profile associated with the intended recipient. Thus, a handheld device with a relatively small display will likely receive personalized presentation created from a different template as compared with content received by a handheld device with a larger display. If the user device profile is not available or does not contain sufficiently detailed information, then a default content format can be selected, such as SMS or text. In the desktop environment, user information for content delivery may be available via Internet cookies or session information or the like.

Another aspect of the personalization operations includes mapping a user's location information to a redemption or retail outlet location based on the user's current known geographic location. That is, the user's static and dynamic location information can be considered and the user's most likely current geographic location can be determined at the time of assembling the personalized presentation, substantially contemporaneously and “on-the-fly”. The user location determination is performed by a location mapping module 418, which receives information from the user profile module 408 and the personalization content module 412. As noted above, GPS information for the user device can be utilized for location, or user location might be determined from telephone cell tower information or network address or from user profile information. That is, user location comprises most likely current geographic location and can be set to a default location such as a static location comprising a home or work contact address, or can be set to a dynamic geographic location based on a GPS position fix or triangulation from handset cell tower information or the like. Other location determination schemes may be utilized to determine user location.

Another aspect of the personalization operations comprises a mapping from user preferences to content, such as promotional content in the case of ads. The content mapping module 420 obtains user preferences from the user profile data and maps the user preferences to promotional content from the ad sources. In this way, the content mapping module determines products or services that might be of interest to the intended recipient that are available from the sponsor on whose behalf a message is being assembled. The module considers the purpose of the promotion or ad campaign, as noted above, and is adapted to highlight or emphasize relevant features based on the user profile.

For example, the content mapping module 420 might be implemented as a software module that executes a process to determine a promotion mapping for an ad campaign involving a new product announcement for a telephone. The product features (and therefore the promotional content) to be emphasized in the campaign may be selected in accordance with the interests of the demographic group with which the intended recipient is associated. For example, if college-attending adolescents are associated with music downloads and female teenagers are determined to be primarily concerned with aesthetics, then intended recipients who are identified as college students might receive telephone ads that emphasize download speed and data throughput, while intended recipients who are identified as teenage females will receive ads for the same telephone that emphasize color or shape. Ad content for the same telephone that is intended for young age groups might emphasize ease of use with “MySpace” accounts, and so forth, in accordance with user preferences and user profile data.

At the template engine 422, information is received comprising the presentation template selected by the presentation template module 416, the retail destination location information from the location mapping module 418, and the product preference information from the content mapping module 420. The template engine 422 fills the dynamic placeholders in the presentation template with data comprising the promotional content selected for the user preferences and the retail location content selected for the current user location. The template with the filled-in information comprising static information and dynamic information comprises the assembled personalized presentation. The personalized presentation is then ready to be provided to the delivery engine 404 for transmission to the user devices 402 (the intended recipients). the location mapping module 418, content mapping module 420, and template engine 422 correspond to the personalization module 112 of FIG. 1 (indicated by dashed lines in FIG. 4).

The template engine 422 illustrated in FIG. 4 can interface with a variety of communications involving the user device of the intended recipient. For example, the template engine 422 can insert personalized presentation, such as an ad message, before a video stream is sent to the user device or after a video stream is sent to the user device. In this way, a multimedia clip, such as an advertising message, can be sent to a user device, and before or after viewing, the user can receive a coupon or promotion or other personalized ad message. Moreover, in conjunction with the high degree of personalization possible with the technique described herein, a playlist of ad messages and/or video clips can be generated in accordance with the personalization operations. An example of operations to perform such processing is provided below, in Table 3:

TABLE 3
For each user in database{

GetUserPreferences( )

GetRelevantPromotionalContent(userprefs)

coupon.AddTemplateRule_Text(“<%USER_NAME%>”, name,
True)
coupon.AddTemplateRule_Image(“<%PROD_IMAGE%>”,
rodImage(product), 0)
coupon.AddTemplateRule_Image(“<%DISCOUNT_IMAGE%>”,
DiscImage(product), 0)
coupon.AddTemplateRule_Image(“<%STORE_IMAGE%>”,
storeImage(zip), 0)

}

Message generation (i.e., generating the assembled messages) can be initiated at the template engine 422 by a variety of triggering means or message initiation mechanisms. For example, message generation can be the result of manual initiation by an administrative user at the personalization system 102 (FIG. 1), or through user pull (user request), user location entering a predetermined geographic area (such as a retail store or cell tower coverage area). Other techniques for identifying an intended recipient for whom a personalized message will be assembled can also be used and will be apparent in view of the discussion herein. The personalization system can comprise an ad server or the like. Upon an event that initiates generating personalized presentation, the ingest module retrieves user profile information for the intended recipient and determines corresponding promotional content with which it generates the personalized presentation. In this way, the personalized presentation is generated “on the fly” in real time, such that content can be produced in response to real time changes in the data for the intended recipient. Thus, the content personalization extends to not only current user location, but also all other aspects of the user profile according to the user profile information available at the time of content generation.

The delivery engine 404 sends the personalized presentation to the intended recipient in accordance with the current location information of the user for whom the content is personalized. This information is obtained from the user profile information and can be received by the delivery engine along with the assembled content from the template engine 422. As known to those skilled in the art, the content delivery process may involve a single or multi-step process according to the delivery format and user network location. For example, for messages in the SMS and MMS formats, the message is delivered with a direct push to the intended recipient handset based on the user's telephone number. For Flash Lite® messages, delivery involves an SMS message with an embedded URL (uniform resource locator) address that specifies the network location of the Flash Lite® file. The receiving user then clicks on the URL link in the received message and initiates a download of the file for viewing. Web pages will be delivered in accordance with Web standards.

In accordance with the personalized presentation technique described herein, the personalized presentation delivered to an intended recipient is more likely to be accepted and viewed, and is more likely to be acted upon in a positive manner, as compared to unsolicited undirected “spam” messages or even messages with personalization in accordance with conventional techniques. As described above, the content is personalized according to the device platform that will receive the content and according to the user preferences of the intended recipient, directed to the location of the intended recipient at the time the content is generated. This is especially efficient in the mobile device context, where the intended recipient user is likely to have a different location each time content is to be generated, so that the present invention permits leveraging current location of the user with a retail or redemption location that is convenient to the user, thereby making user response to the content easier, and making use of message formats tailored for best presentation at the device being used by the intended recipient.

Content personalization as described herein provides personalization to the extent of the particular intended recipient and that individual person's interests. Thus, personalization can extend to include a combination of data for an ad based on multiple personal details. In that way, the personalized presentation can be generated with a greater degree of granularity for personalization. For example, many retail establishments such as grocery stores promote membership in a “frequent shopper” group or “club” or the like. Such retailers often collect shopping information and account information regarding members of the club, with the authorization of club members. The system described herein can take advantage of efficiencies in such club aggregated data to generate the personalized presentation described herein.

For example, a retail establishment with such a shopper's club could very easily run a highly personalized ad campaign directed to everyone who has membership in the shopper's club. For those members who opt in or authorize such messaging, all the relevant data such as user product preferences, shopping history, location, and the like would be known by the retail establishment and could potentially be available to the ad server for generating personalized ad messages. That is, such shopper club member information could easily be accepted through the data input (ingestion) process described herein and used to generate highly personalized ad messages for delivery to those shopper club members. In that case, the messages would be prepared only for those persons who indicated a desire to receive such messages. Thus, such messages would not likely be considered unsolicited spam comprising an intrusion, but would be accepted. Therefore, it is more likely they would receive a positive response (i.e., coupons would be used and products would be purchased).

The system and methods described herein provide messages that are customized to a personal extent that is beyond what is currently available, using a combination of message templates, personal information, and promotional information. The message templates specify a message format, such as SMS, MMS, html, text message, and so forth, that are dependant on the user device, such as cell phone, Blackberry, and the like. The device profile information can be kept in a user profile database that also stores other information relating to users who are potential intended recipients of the personalized messages, such as user preferences and account information. The user profile database contains user information of persons who have authorized the sending of personalized messages, and therefore the personalized messages should be more readily accepted and acted upon. The ad message subject content includes advertising and promotional content to be placed in the personalized message. The location content can include information for the nearest retail location at which the intended recipient can obtain the advertised product or promotion, or redeem a coupon sent with the message. The location content can include static data (such as recipient home address) and dynamic data (such as current GPS coordinates of the recipient).

Each of the various operational components describe above, such as the modules 408, 412, 416, 418, 420 and the template engine 422 and delivery engine 404 can be implemented as computer devices that execute instructions to perform the operations and functions described above. Each of these operational components can be provided as independently functioning units, or can be integrated as components that include one or more of the operational components. Each computer device that implements the functions and operations described herein will include a computer processor, network communications capability, data storage, and input/output facilities necessary to carry out their respective intended functions.

The present invention has been described above in terms of a presently preferred embodiment so that an understanding of the present invention can be conveyed. There are, however, many configurations for personalized presentation systems not specifically described herein but with which the present invention is applicable. The present invention should therefore not be seen as limited to the particular embodiments described herein, but rather, it should be understood that the present invention has wide applicability with respect to personalized presentation systems generally. All modifications, variations, or equivalent arrangements and implementations that are within the scope of the attached claims should therefore be considered within the scope of the invention.

I claim:

1. A method of providing content through a network communication system, the method comprising:
selecting personalization content for an associated presentation template in accordance with contemporaneous information relating to an intended recipient;
generating a personalized presentation comprising the selected personalization content and the associated presentation template such that the personalized presentation can be provided to the intended recipient.

2. A method according to claim 1, wherein the contemporaneous information relating to the intended recipient includes user preferences of the intended recipient, device resources information, and user location of the intended recipient.

3. A method according to claim 1, further including:
delivering the personalized presentation to the intended recipient over a network communication session.

4. A method according to claim 3, wherein delivering comprises inserting the personalized presentation within a video stream for delivery to the intended recipient.

5. A method according to claim 1, wherein selecting personalization content comprises:
receiving feedback relating to communication conditions over a network communication session with the intended recipient; and
selecting the personalization content from among multiple alternative versions of content in accordance with the feedback.

6. A method according to claim 5, wherein receiving feedback occurs at a minimally sufficient time to perform the selecting personalization content and generating a personalized presentation for delivery.

7. A method according to claim 5, wherein the multiple alternative versions comprise versions of otherwise identical content such that each version is associated with a different resource requirement for delivery to the intended recipient.

8. A method according to claim 1, wherein the personalized presentation includes a coupon for redemption.

9. A method comprising:
identifying an intended recipient for whom a personalized presentation will be generated;
selecting a presentation template in accordance with user profile information of the intended recipient;
selecting personalization content for the personalized presentation in accordance with user preference data;
selecting location content for the personalized presentation in accordance with user location data;
generating the personalized presentation based on the selected presentation template in accordance with the selected personalization content and the selected location content.

10. A method as defined in claim 9, wherein:
the device profile is obtained from a user profile database that contains user profile information on multiple persons, each of which can be selected as an intended recipient; and
the user profile information relates to persons who have authorized receipt of assembled presentations.

11. A method as defined in claim 9, wherein generating the assembled presentation includes:
mapping user preference information to a promotional content database from which the selected subject content is obtained;
mapping static location information of the intended recipient and dynamic location information of the intended recipient to identify the selected location content.

12. A method as defined in claim 9, further including:
delivering the personalized presentation to the intended recipient over a network communication session.

13. A method as defined in claim 12, wherein delivering comprises inserting the personalized presentation within a video stream for delivery to the intended recipient.

14. A method as defined in claim 9, wherein selecting personalization content comprises:
receiving feedback relating to communication conditions over a network communication session with the intended recipient; and
selecting the personalization content from among multiple alternative versions of content in accordance with the feedback.

15. A method as defined in claim 14, wherein receiving feedback occurs at a minimally sufficient time to perform the selecting personalization content and generating a personalized presentation for delivery.

16. A method as defined in claim 14, wherein the multiple alternative versions comprise versions of otherwise identical content such that each version is associated with a different resource requirement for delivery to the intended recipient.

17. A system for producing content for delivery through a network communication system, the presentation system comprising:
an ingest module that maintains presentation template information and personalization content; and
a template engine that generates an personalized presentation for an intended recipient in accordance with personalization content and presentation template information selected from the ingest module in accordance with contemporaneous information relating to the intended recipient.

18. A system according to claim 17, wherein the contemporaneous information relating to the intended recipient includes user preferences, device resources information, and user location of the intended recipient.

19. A system according to claim 17, further including:
a delivery engine configured to deliver the personalized presentation to the intended recipient over a network communication session.

20. A system according to claim 19, wherein the delivery engine inserts the personalized presentation within a video stream for delivery to the intended recipient.

21. A system according to claim 17, wherein the template engine selects personalization content in accordance with received feedback relating to communication conditions over a network communication session with the intended recipient and wherein the selected personalization content is selected from among multiple alternative versions of content in accordance with the feedback.

22. A system according to claim 21, wherein the received feedback is received at a minimally sufficient time to perform the selecting personalization content and generating a personalized presentation for delivery.

23. A system according to claim 21, wherein the multiple alternative versions comprise versions of otherwise identical content such that each version is associated with a different resource requirement for delivery to the intended recipient.

24. A system according to claim 17, wherein the personalized presentation includes a coupon for redemption.
